(19) United States
(12) Patent Application Publication
(10) Pub. No.: US 2006/0133324 A1
(43) Pub. Date: Jun. 22, 2006

(54) Method for data transmission and communication between telephone lines and a net

(76) Inventor: Schlomi Nahon, Lehavim (IL)

Correspondence Address: Angenehm Law Firm. Ltd., P.O. Box 48755, Coon Rapids, MN, 55448-0755, US

(21) Appl. No.: 11/271,086

(22) Filed: Nov. 12, 2005

Related U.S. Application Data
(60) Provisional application No. 60/627,390, filed on Nov. 12, 2004.

(51) Int. Cl. H04B 7/216

(52) U.S. Cl. 370/335

(57) ABSTRACT

A method for data communication and transmission between telephone lines and a net including the steps of: dialing an operator using a telephone line; displaying an options menu; selecting a mode of input from the group consisting of voice and electronic; selecting a desirable option of said option menu using the mode of input; sending a signal to said computer according to said desirable option; resolving and identifying said signal by a signal creator software on said computer; and referring the user to said desirable option according to said signal that is identified.

### FIELD OF THE INVENTION

The present invention relates to data transmission communication, claiming priority from U.S. Provisional Patent Application No. 60/627,390, filed Nov. 12, 2004 and having the same title hereof. More particularly, the present invention relates to data communication and transmission between telephone lines and a net.

### BACKGROUND OF THE INVENTION

The internet, while actually having started decades ago, has become a vast source of knowledge and information used in the late 1990's and early 2000's. This resource has limitations that prevent certain people from accessing the vast wealth of knowledge.

Currently, one needs a computer, software, modem, an ISP (Internet Service Provider) and the ability to use the same in order to access the net. These materials are often available, which has led to the high usage of the internet. However, few people carry a computer wherever they may go and many others wouldn't be able to use the materials if they were available. For instance, blind persons cannot read a computer screen. Others lack the knowledge of how to access the internet. In part, this non-availability to all persons is related to the length of time that the internet has been a popular tool.

Telephones have been available for much longer periods of time. Phones have developed such that they are understood by nearly all persons. Moreover, the technology has developed such that persons with physical disabilities, including blindness, are able to comfortably operate a telephone. Time has allowed the technology of the telephone to develop such that is accommodates all persons at nearly all times and locations for ease of use. Generally, however, telephones when used by one person tend to be limited to communication between people or listening to pre-recorded messages.

What is needed is a combining of the resources available on the internet, with the ease of use and availability of a telephone. Desirably, the internet may be accessed through voice communication instead of keyboard operation. In this manner, one not familiar with the operation of a computer or associated software may simply make a voice request for that which they want to access. The retrieved information should be accessible either on a computer screen or through a vocalization of the contents. This allows those who cannot see a computer screen to still access the content for which they search.

### SUMMARY OF THE INVENTION

The present invention is an inventive combination of the resources available on the internet, with the ease of use and availability of a telephone. The internet may be accessed through voice communication instead of keyboard operation, allowing those not familiar with the operation of a computer or associated software to simply make a voice request for that which they want to access. The retrieved information may be accessible either on a computer screen or through a vocalization of the contents, allowing those who cannot see a computer screen to still access the content for which they search.

The method, according to the present invention, for data communication and transmission between telephone lines and a net may include the steps of: dialing an operator using a telephone line; displaying an options menu; selecting a mode of input from the group consisting of voice and electronic; selecting a desirable option of said option menu using the mode of input; sending a signal to said computer according to said desirable option; resolving and identifying said signal by a signal creator software on said computer; and referring the user to said desirable option according to said signal that is identified.

Advantageously, a user may access a website, a listing of professionals, send an e-mail message or engage in other internet activity with or without the aid of a computer.

As still yet another advantage, the present system provide a new communication mechanism between a computer and telephone lines. The present invention is adapted to facilitate the communication between service providers and clients, for example. The present invention allows communication of people that are not familiar with computer to connect to sites.

As still yet another advantage, those who are unable to see or operate a computer may access the same information available to those who have such abilities and capabilities.

As a further advantage, one who desires to view the internet searching may do so an communicate orally with the computer system.

These and other advantages will become clear through reading the detailed description below with reference to the drawings.

### BRIEF DESCRIPTION OF THE FIGURES

In order to better understand the present invention and appreciate its practical applications, the following Figures are attached and references herein. Like components are denoted by like reference numerals.

It should be noted that the figures are given as examples and preferred embodiments only and in no way limit the scope of the present invention as defined in the appending Description and Claims.

FIG. 1 illustrates a general flowchart of communication means in accordance with a preferred embodiment of the present invention.

FIG. 2 illustrates an example of referring to identifying signal creator software in accordance with a preferred embodiment of the present invention.

FIG. 3 illustrates a use of the method by voicing a signal in accordance with a preferred embodiment of the present invention.

FIG. 4 illustrates an internet site opening by playing a commercial advertisement in accordance with a preferred embodiment of the present invention.

FIG. 5 illustrates a written message transmission during a phone call in accordance with a preferred embodiment of the present invention.

FIG. 6 illustrates a phone number display while calling to phone service information in accordance with a preferred embodiment of the present invention.

FIG. 7 illustrates a remote controlling of a computer by a telephone in accordance with a preferred embodiment of the present invention.

FIG. 8 illustrates a user referring to a wanted service in accordance with a preferred embodiment of the present invention.

### DETAILED DESCRIPTION OF THE INVENTION AND FIGURES

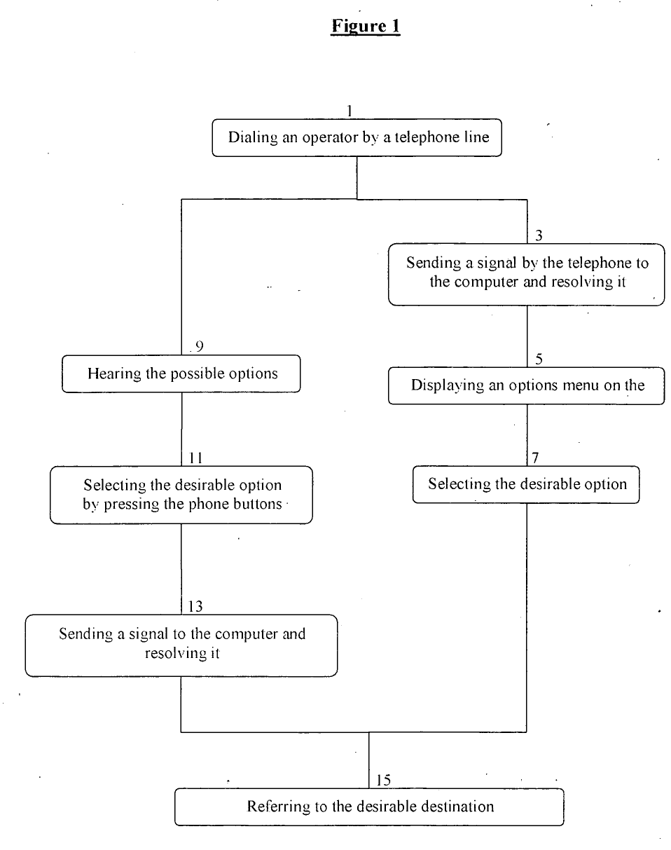

Reference is now made to FIG. 1 illustrating a general flowchart of a communication means in accordance with a preferred embodiment of the present invention. A user of the present invention dials to an operator by a telephone line 1. “Operator” is intended to include human, electronic, mechanical and other such transitional communication points along a telephone line. The user can continue the process preferably by using one of two options: the computer or the telephone. If the choice of the user is using the computer, the user sends a signal by the telephone to the computer and the computer resolves the signal to digital information 3 by using identifying signal creator software. A menu of the possible options is displayed on the computer screen 5 and the user has to select his desirable option 7. According to the user choice, he is referred to desirable destination 15. If the user, after dialing the computer 1, continues the process by using the telephone, then, after dialing the operator, he hears the possible options in the telephone line 9. By pressing the phone buttons, the user selects his desirable option 11, respectively a signal is send to the computer 13. After the computer resolves the signal, by using identifying signal creator software, the user is referred to his desirable destination 15.

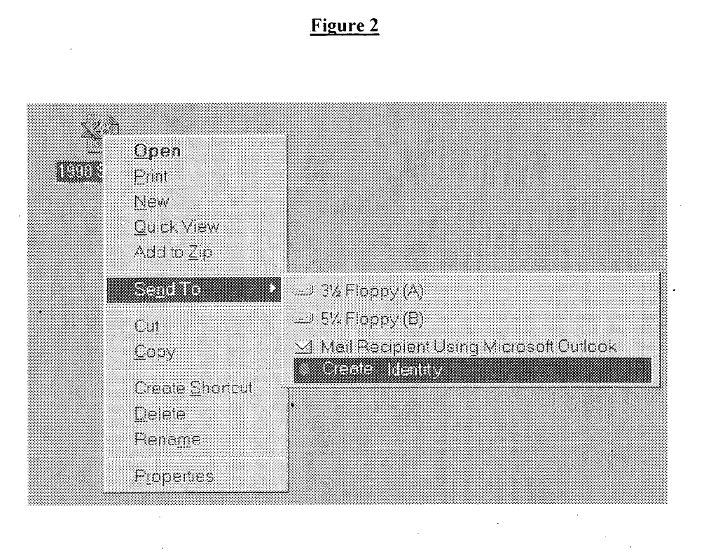

Reference is now made to FIG. 2 illustrating an example of referring to identifying signal creator software in accordance with a preferred embodiment of the present invention. An application of entering the software using Windows as the operating system of the user computer.

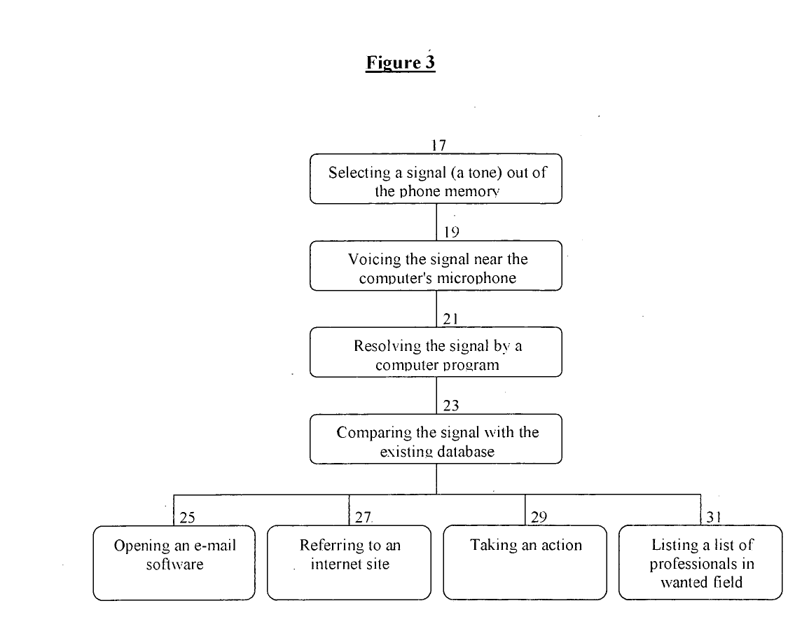

Reference is now made to FIG. 3 illustrating a use of the method by voicing a signal in accordance with a preferred embodiment of the present invention. A predefined signal (a tone) is selected out of the telephone memory 17. The user voices the signal near the computer's microphone 19, the computer receives the signal and resolves it into digital information 21, by using identifying signal creator software. The signal is compared with the existing database 23 and according to it the computer acts according to the request of the user while the actions can be one of several examples such as opening an e-mail software 25, referring to an internet site 27, taking an action 29, or listing a list of professionals in wanted field 31.

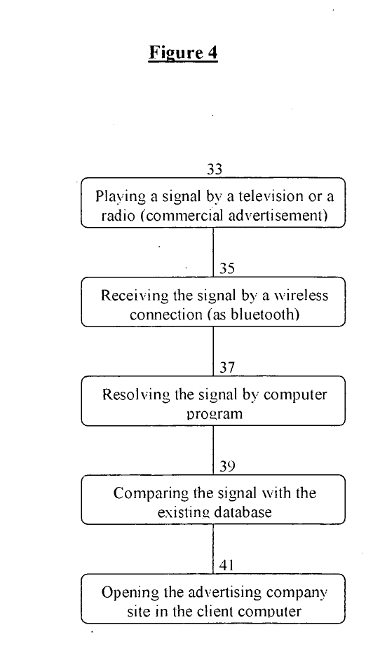

Reference is now made to FIG. 4 illustrating an internet site opening by playing a commercial advertisement in accordance with a preferred embodiment of the present invention. A signal as commercial advertisement is played by a television or a radio 33. The computer receives the signal by a wireless connection as Bluetooth 35 and resolve it 37, by using identifying signal creator software. The signal is compared with the existing database 39 and according to it the computer opens the advertising company site 41.

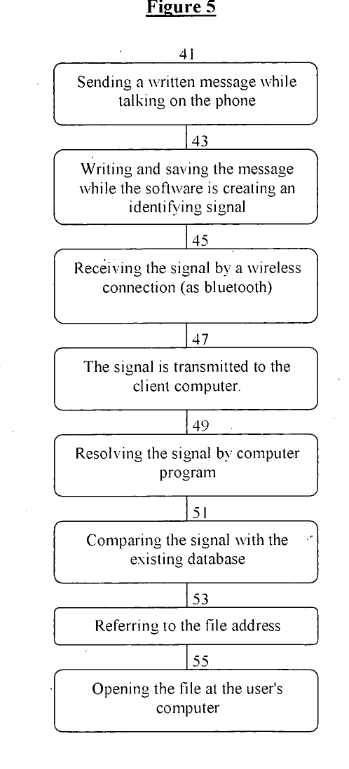

Reference is now made to FIG. 5 illustrating a written message transmission during a phone call in accordance with a preferred embodiment of the present invention. During a phone call, one of the sides wishes to send a written message 41. The user writes and saves his message. While saving the message the computer creates an identifying signal, by using identifying signal creator software, and transmits it to an internet address 43. The signal is received by a wireless connection, as Bluetooth 45 and transmits it to the user's computer 47. After resolving the signal 49 and comparing it with the database 51, the computer refers to the file address 53 and opens the file at the user's computer 55.

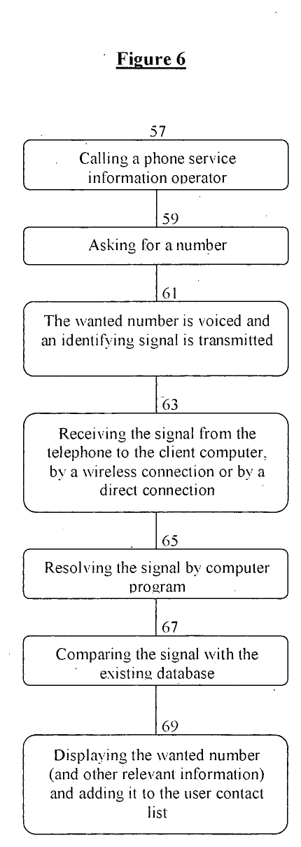

Reference is now made to FIG. 6 illustrating a phone number display while calling to phone service information in accordance with a preferred embodiment of the present invention. The user calls a phone service information operator 57 and asks for a phone number 59. The desirable number is voiced and respectively an identifying signal is transmitted 61. The signal is received at the user computer by a wireless connection or by a direct connection 63. After resolving the signal 65, by using identifying signal creator software, and comparing it with the database 67, the number and other relevant information are displayed on the computer screen and added to the user contact list 69.

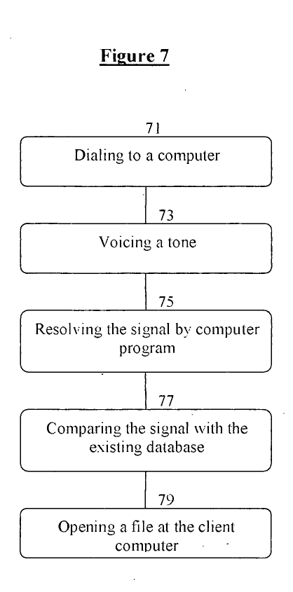

Reference is now made to FIG. 7 illustrating a remote controlling of a computer by a telephone in accordance with a preferred embodiment of the present invention. The user dials to a computer 71 in a manner discussed herein before, and a respective tone is voiced near the computer 73. The computer resolves and compares the signal with its database 75, 77 and according to it the computer takes an action at the user's computer as opening a file 79.

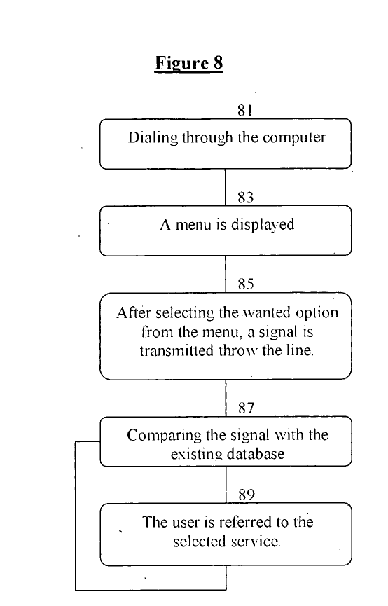

Reference is now made to FIG. 8 illustrating a user referring to a wanted service in accordance with a preferred embodiment of the present invention. The user dials through the computer 81 and respectively a menu of possible services is displayed 83. After selecting the desirable option from the menu, a signal is transmitted and compared with the database 85, 87. The user is referred to his selected service 89.

It should be clear that the description of the embodiments and attached Figures set forth in this specification serves only for a better understanding of the invention, without limiting its scope as covered by the following Claims.

It should also be clear that a person skilled in the art, after reading the present specification can make adjustments or amendments to the attached Figures and above described embodiments that would still be covered by the following Claims.

1) A method for data communication and transmission between telephone lines and a net comprising the steps of:
dialing an operator using a telephone line;
displaying an options menu;
selecting a mode of input from the group consisting of voice and electronic;
selecting a desirable option of said option menu using the mode of input;
sending a signal to said computer according to said desirable option;
resolving and identifying said signal by a signal creator software on said computer; and
referring the user to said desirable option according to said signal that is identified.

2) The system as claimed in claim 1, wherein the step of displaying said options menu further comprises the step of:
selecting a mode of displaying said options menu from the group consisting of voice on a telephone line and electronic on a computer monitor.

3) The system as claimed in claim 1, wherein said sending a signal to said computer is made by a wireless connection.

4) The system as claimed in claim 1, wherein said selecting a desirable option is communicated by voice on the telephone lines.

5) The system as claimed in claim 1, wherein said selecting a desirable option is communicated by pressing phone buttons.

6) The system as claimed in claim 1, wherein said signal creator software is provided with a database to which said desirable option is compared.

7) The system as claimed in claim 1, wherein said desirable option is opening a file.

8) The system as claimed in claim 1, wherein said desirable option is opening a website.

9) The system as claimed in claim 1, wherein said desirable option is sending an e-mail message.

10) A method for data communication and transmission between telephone lines and a net comprising the steps of:
dialing an operator using a telephone line;
displaying an options menu on a computer;
voice selecting a desirable option of said option menu;
sending a signal to said computer according to said desirable option;
resolving and identifying said signal by a signal creator software on said computer; and
referring the user to said desirable option according to said signal that is identified.

11) The system as claimed in claim 10, wherein said sending a signal to said computer is made by a wireless connection.

12) The system as claimed in claim 10, wherein said selecting a desirable option is communicated by voice on the telephone lines.

13) The system as claimed in claim 10, wherein said selecting a desirable option is at least in part communicated by pressing phone buttons.

14) The system as claimed in claim 10, wherein said signal creator software is provided with a database to which said desirable option is compared.

15) The system as claimed in claim 10, wherein said desirable option is opening a file.

16) The system as claimed in claim 10, wherein said desirable option is opening a website.

17) The system as claimed in claim 10, wherein said desirable option is sending an e-mail message.

18) A method for data communication and transmission between telephone lines and a net comprising the steps of:
dialing an operator using a telephone line;
displaying an options menu on a computer;
selecting a desirable option of said option menu using telephone buttons;
sending a signal to said computer according to said desirable option;
resolving and identifying said signal by a signal creator software on said computer; and
referring the user to said desirable option according to said signal that is identified.

19) The system as claimed in claim 18, wherein the step of displaying said options menu further comprises the step of:
selecting a mode of displaying said options menu from the group consisting of voice on a telephone line and electronic on a computer monitor.

20) The system as claimed in claim 18, wherein said sending a signal to said computer is made by a wireless connection.

21) The system as claimed in claim 18, wherein said selecting a desirable option is in part communicated by voice on the telephone lines.

22) The system as claimed in claim 18, wherein said selecting a desirable option is exclusively communicated by pressing phone buttons.

23) The system as claimed in claim 18, wherein said signal creator software is provided with a database to which said desirable option is compared.

24) The system as claimed in claim 18, wherein said desirable option is opening a file.

25) The system as claimed in claim 18, wherein said desirable option is opening a website.

26) The system as claimed in claim 18, wherein said desirable option is sending an e-mail message.
